(19) United States
(12) Patent Application Publication
(10) Pub. No.: US 2009/0035496 A1
(43) Pub. Date: Feb. 5, 2009

(54) Bag With Three Dimensional Designs

(75) Inventors: Yukio Nakagawa, Shiga (JP); Yoshio Iwasaki, Shiga (JP); Taro Hijikata, Shiga (JP)

Correspondence Address: HOGAN & HARTSON L.L.P., 1999 AVENUE OF THE STARS, SUITE 1400, LOS ANGELES, CA, 90067, US

(73) Assignee: ISHIDA CO., LTD., Kyoto-shi, Kyoto (JP)

(21) Appl. No.: 12/162,976

(22) PCT Filed: Apr. 27, 2007
(86) PCT No.: PCT/JP2007/059245

§ 371 Date: Jul. 31, 2008

(30) Foreign Application Priority Data
Apr. 28, 2006 (JP) 2006-126014
Apr. 28, 2006 (JP) 2006-126052
Jun. 26, 2006 (JP) 2006-175654

(51) Int. Cl. B32B 1/04

(52) U.S. Cl. 428/34.1

(57) ABSTRACT

In a bag 10 in which a laminating film 11 is formed with a substrate layer 13 and a sealant layer 12 sealed in the vertical and horizontal direction and which is provided with the front surface and the rear surface, three dimensional designs molded by a mold are formed on at least either front surface or the rear surface of the bag. As specific means, the methods include the one for imparting the three dimensional designs by the mold to the film with an enhanced shape retention property by providing a reinforcement sheet 14 on the inner side surface of the laminating film 11 or by providing a three dimensional designing sheet 15 on the outer side surface of the laminating film 11 or the one for laminating the three dimensional sheet 16 in which the three dimensional designs are formed beforehand by the mold on the outer side surface of the laminating film 11 by a hot melt adhesive 16A.

### FIELD OF THE INVENTION

The present invention relates to a bag with three dimensional designs. In more detail, the present invention relates to a technique for imparting three dimensional designs to packaging bags for snack foods such as potato chips and the like or sweets such as biscuits and the like formed by laminating films for the packaging bags.

### BACKGROUND OF THE INVENTION

Snacks such as potato chips and the like or sweets such as biscuits and the like are filled in bags formed of plastic laminating films by vertical or horizontal bag making-packaging machines at factories where these foods are produced, and are shipped, and then are sold at stores such as super markets and the like.

On both front and rear surfaces of the packaging bags, information is printed that includes not only basic information on products such as the products' names, ingredient tables for foods, best-before dates, manufacturers' names, and the like, but also other information for the manufacturers to stimulate consumer appetite. Consumers see the packaging bags of the products and the information and the like printed thereon and judge whether they should buy the products. Therefore, each of the food manufacturers is dedicated to printing designs so that they catch the consumers' eyes since the printings of the packaging bags affect greatly on purchase judgment by the consumers.

Generally, a laminating film that forms a bag is basically formed of a sealant layer, a barrier layer, and a substrate layer laminated, and each of the layers shares the different functions for the bag. The sealant layer allows heat seal for forming a bag. The barrier layer is generally constituted of a ceramic vapor deposition layer such as aluminum, aluminum oxide, silicon oxide, or the like, an ethylene-vinyl alcohol copolymer resin layer, and an oxygen-absorption layer that includes reduced iron, and the like and the barrier layer protects the foods therein against water and oxygen. Lastly, the substrate layer provides mechanical properties to the bag.

This laminating film is supplied from a film roll to a packaging machine and the packaging bag is formed. As one example of such a packaging machine, a vertical bag-making and packaging machine is shown in FIG. 10. The vertical bag-making and packaging machine 20 has a former 23 for receiving a plane laminating film 11 to form it into tubular and the former 23 has a shoulder portion 23a and a tubular portion 23b.

Conveyed by a pull-down belt 24c, the laminating film 11 is formed into tubular in the process of running from the shoulder portion 23a of the former 23 to the tubular portion 23b and a vertical seal is formed by the vertical seal mechanism 21 with both end surfaces in the running direction (vertical direction) of the film overlapped. Subsequently, horizontal seal is performed by horizontal seal mechanism 22 perpendicular to the running direction with spaces that depend on bag length, while the food C put in the tubular laminating film 11 is filled through an inside cavity of the tubular portion 23b of the former 23, and is cut to form a bag. Since the packaging bag is formed by the above mentioned process, on a surface in the side of the former 23 of the laminating film 11, a sealant layer is provided and on a surface that is outside of the former 23, a substrate layer is provided. In addition, between the sealant layer and the substrate layer, a barrier layer is provided.

In a laminating film with such a basic structure, generally, a printing layer is provided to the surface of the bag, outside of the substrate layer, or between the substrate layer (transparent) and barrier layer (opaque) so that consumers see it at stores. However, printing is plane after all no matter how diversified in colors and its impression on the consumers has not been satisfactory enough.

Examples of performing three dimensional printings include the display in Braille on bags (Patent Document 1: Japan Unexamined Patent Publication H11-292091), however, the display remains secondary after all and it is hoped to differentiate the products by performing three dimensional designs that would give strong impression to the consumers.

Therefore, the object of the present invention is to form three dimensional designs for a packaging bag formed of a laminating film that packages food and the like so that it could appeal the product to the consumers and to provide a bag with three dimensional designs formed.

In order to solve the above mentioned problems, the bag of the present invention has its most important characteristics in that it is provided with a front surface and a rear surface with a laminating film having a substrate layer and a sealant layer sealed in the vertical direction and in the horizontal direction, in which three dimensional designs are formed by a mold on at least either of the front surface or the rear surface of the packaging bag.

Specific means include methods of imparting three dimensional designs to the films by the mold with an enhanced retaining shape property by providing the reinforcement sheet on the inner side surface (sealant layer side) of the laminating film or by providing sheets for three dimensional designs on the outer side surface (substrate layer side) of the laminating film, and methods of laminating the three dimensional sheets with the three dimensional designs already formed by the mold on the outer side surface of the laminating film. Further, from the view point of improving designing properties in addition to long term retention of the three dimensional designs, when the methods for using the sheets for the three dimensional designs are employed, it is preferable to include paper with extendable property provided by fine unevenness as materials for the sheets for the three dimensional designs.

In addition, in order to retain the imparted three dimensional designs for a long term, it is preferable to laminate the reinforcement sheet on the inner side surface of the packaging film of the laminating film that includes the range where the three dimensional designs are formed and that excludes the sealed range.

### EFFECT OF THE INVENTION

Since in the packaging bag of the present invention, by being molded by a mold, three dimensional designs with the dimensional shapes abundant in three dimensional feelings are provided at predetermined positions on its outer side surface, it easily catches consumers' eyes and therefore, the appealing effect of the products is great and it can enhance the advertisement effect of the products.

Further, in the present invention, when the reinforcement sheet is laminated on the inner side surface of the laminating film on the surface where the three dimensional designs are formed, in forming the three dimensional designs by the mold, the three dimensional designs that are once formed can retain the state of the three dimensional designs imparted for a long term resisting the restoring force of the laminating film. In addition, in the three dimensional molding by the mold, scratches are hardly generated on the laminating film which does not affect the airtightness that is required for the packaging bags. Moreover, since such reinforcement sheet is provided on the inner side surface (the sealant layer side) that cannot be observed from the outer side surface, the designs of the outer side surface can be retained as they are. Also, by providing the reinforcement sheet on the positions that exclude the horizontal seal portions and the vertical seal portions, the airtightness required for the laminating film is not affected, either.

Further, in the present invention, when the paper with extendable property provided by fine unevenness is laminated on the substrate layer side thereby imparting the three dimensional designs, the effect of appealing to the consumer is great since the further clarified three dimensional designs are formed on this paper substrate by vacuum molding, vacuum press molding, press molding, or emboss molding.

### BRIEF EXPLANATION OF DRAWINGS

FIG. 1A is a schematic sectional view showing the structure of a bag of the present invention.

FIG. 1B is a schematic sectional view showing the structure of another bag of the present invention.

FIG. 2 is a schematic sectional view showing the structure of another bag of the present invention.

FIG. 3 is a schematic sectional view showing the structure of another bag of the present invention.

FIG. 4A is a schematic sectional view viewed from the direction above of the bag making-packaging machine with the mold built in.

FIG. 4B is a schematic view viewed from the lateral direction of the bag making-packaging machine with the mold built in.

FIG. 5 is a schematic view showing one example of the mold used in the present invention.

FIG. 6 is a schematic view of the heater plate to which the reinforcement sheet is attached.

FIG. 7 is a schematic view of the pivotal portion of the bonding mechanism to which the three dimensional sheet is attached.

FIG. 8A is a schematic view viewed from the lateral direction of the bag making-packaging machine with the bonding mechanism built in.

FIG. 8B is a schematic view taken along the line X-X′ in the FIG. 8A.

FIG. 9 is a schematic view showing the appearance of the packaging bag of the present invention.

FIG. 10 is a schematic view of the general vertical bag making-packaging machine used for producing the packaging bag.

### EXPLANATION OF LETTERS OR NUMERALS

10 shows a bag with three dimensional designs

11 shows a laminating film

12 shows a sealant layer

13 shows a substrate layer

14 shows a reinforcement sheet

15 shows a three dimensional designing sheet

16 shows a three dimensional sheet

16A shows a hot melt adhesive

17 shows a barrier layer

18 shows an adhesive

19 shows a printing layer

20 shows a bag making-packaging machine

21 shows a vertical seal mechanism

22 shows a horizontal seal mechanism

23 shows a former

23a shows a shoulder portion

23b shows a tubular portion

24 shows a pull-down mechanism

24a and 24b show a roller, respectively

24c shows a belt

25 and 25′ show a heater plate, respectively

26A shows a male mold

26B shows a female mold

26C shows a blower of the mold

27A shows a bonding apparatus

27B shows a moving mechanism

27C shows a sensor

27D shows a controlling mechanism

27E shows a spraying mechanism

30 shows a three dimensional design

### DETAILED DESCRIPTION OF THE PREFERRED EMBODIMENTS

### Sealant Layer

Since it is preferable that the sealant layer is melted under a low melting point (not higher than 160° C., and preferably not higher than 120° C.), through a common procedure, a cast polypropylene (CPP) is used for the sealant layer 12 of the laminating film 11 used in the present invention, however, a heat-sealable biaxial oriented polypropylene (OPH) can also be used. It is preferable that the heat-sealable layer of a cast polypropylene and the heat-sealable biaxial oriented polypropylene is formed by a copolymer of propylene and other olefin (ethylene, butane, and the like) or that a layer that includes a low density polyethylene (straight-chain low density polyethylene and the like polymerized by metallocene catalyst) and an ethylene-vinyl acetate copolymer is formed on the cast or biaxial oriented polypropylene so that they can be melted at a low temperature. In addition, the sealant layer 12 may also be formed not only of polyolefin but also of polyester with low melting point. As polyester with low melting point, copolymerized polyester of ethylene terephthalate and cyclohexanediol of EASTMAN KODAK CO. can be exemplified.

Also, as a film for the sealant layer 12, the one with the polymers with a high melting point (biaxial oriented polypropylene and biaxial oriented polyester) laminated on the above mentioned polymers with a low melting point may be used. As thickness of such a sealant layer 12, 20 to 50 μm is preferable.

### Barrier Layer

As aforementioned, it is preferable that the laminating film 11 used in the present invention has an ordinary barrier layer 17 formed by vapor depositing metals such as aluminum, iron, magnesium, and the like or by vapor depositing ceramics such as silicon oxide and the like. As a thickness for the barrier layer 17, in view of a light blocking property and an oxygen-water vapor blocking property, not less than 300 Å is preferable and the thickness is selected among 300 to 1500 Å. This barrier layer 17 formed by the method of vapor deposition and the like can be formed on either of the surfaces of the substrate layer side of the sealant layer 12 or of the sealant layer side of the substrate layer 13. When the barrier layer 17 is formed on the surface of the sealant layer, it is preferable to laminate the polymer layer as the material used for the sealant layer 12 on the polymer layer with low melting point with the former having higher melting point than the latter and to form the barrier layer 17 in the polymer layer side with high melting point by such methods as vapor deposition and the like. Also, the barrier layer 17 may be formed not of the above mentioned vapor deposited layer but of an ethylene vinyl alcohol film or a film that includes reduced iron or cobalt in combinations with the vapor deposited layer.

### Substrate Layer

Since the substrate layer 13 is a main constituent that forms the bag 10, the substrate layer 13 is required to have high tensile strength and appropriate hardness as well as to have a heat resistant property durable for heat seal at the time of forming bags, and it is preferable that the substrate layer is constituted of a biaxial oriented polypropylene film (OPP) and of a biaxial oriented polyester film since the cost should be kept low. In addition, when a heat-sealable property is also required for the outer side surface of the bag 10, a sealant layer is further formed on the outer side surface of the OPP film or of the biaxial polyester film or a heat-sealable biaxial oriented polypropylene film (OPH) or a heat-sealable biaxial polyethylene terephthalate film is used. As thickness of the substrate layer, the range of 15 to 50 μm is preferable.

### Adhesive

When the sealant layer 12 and the substrate layer 13 are laminated, the laminating film 11 is obtained. As methods for laminating, dry-lamination laminating with an adhesive interposed or sandwich-lamination laminating by extruding polyethylene between both layers at a thickness of around 10 to 30 μm can be exemplified. As adhesives 18 used for lamination, two-liquid solution whose main ingredients are polyether and polyurethane, adhesives with the polymer of aromatic polyether series, aromatic polyester series, aliphatic polyester series, aliphatic polyurethane series, aliphatic polyether series dissolved in the solvent, and the adhesives 18 of hot melted type such as copolymer of ethylene acrylic acid, copolymer of ethylene methacrylate, copolymer of ethylene acrylate, and the like can be used.

### Basic Structure of the Laminating Film

A basic structure provided at least with the laminating film 11 that constitutes the bag 10 of the present invention has the sealant layer 12 of the inner side surface and the substrate layer 13 of the outer side surface as mentioned above. Further, in order to enhance the sealing property of the bag 10, it is preferable to provide the barrier layer 17 between the sealant layer 12 and the substrate layer 13. In addition, from a further commercial view point, the printing layer 19 is provided at a position visible from the outer side of the bag 10 such as the outermost layer of the bag 10, for example.

### Constituent For Imparting Three Dimensional Designs

However, when the three dimensional designs are to be decorated on the surface of the bag 10 produced with the laminating film 11 constituted only of the above mentioned basic structure by forming patterns by the mold, since the laminating film 11 are so thin that even with forming patterns, the three dimensional decorating effect by it can hardly be expected. In addition, the bag 10 is, in its nature, required for a shape retention property against the three dimensional decoration performed on the surface.

Therefore, in the bag 10 of the present invention, it is preferable that, in addition to the basic structure of the laminating film 11, any one of the additional components below is added by such methods as laminating and the like.

It is preferable that the reinforcement sheet 14 is firstly laminated further inside of the sealant layer 12 of the laminating film 11, followed by imparting the three dimensional designs to the laminating film 11 together with the reinforcement sheet 14 by the mold.

Or it may be that the three dimensional designing sheet 15 is laminated to the side of the substrate layer 13 of the laminating film 11, followed by imparting the three dimensional designs to the laminating film 11 together with the sheet for the three dimensional designing sheet 15 by the mold.

Or it may be that the three dimensional sheet 16 with the three dimensional designs formed by the mold is further laminated to the outer side surface of the substrate layer 13.

### Reinforcement Sheet

It is preferable that a reinforcement sheet 14 is further laminated on the inner side surface (sealant layer side) of the laminating film 11 in addition to the basic structure of the laminating film 11. The reinforcement sheet 14 is a layer for reinforcing the portion of the laminating film 11 subject to the three dimensional designs from the rear surface in order to apply the three dimensional design decoration to the bag 10. For the reinforcement sheet 14 used in the present invention, materials with a thermoplastic property are selected as materials with a high retaining shape property under room temperature and with light weight. In other words, at the time of embossing the laminating film 11, the three dimensional designs can be easily imparted by heating while when cooled to room temperature, the three dimensional designs have a relatively high retaining shape property.

As specific materials, thermoplastic resins such as polyethylene or polypropylene can be exemplified. Further, it is preferable that the thickness of the reinforcement sheet 14 is 30 to 200 μm. When the reinforcement sheet is too thin, the effect of providing the three dimensional decoration to the surface of the packaging bag is not satisfactory enough, while on the other hand, when the reinforcement sheet is too thick, since the reinforcement sheet 14 is partially formed on the laminating film 11, it gets difficult to form the laminating film 11 in tubular and the process passing capability is likely to be disrupted.

The reinforcement sheet 14 can be laminated by bonding to the laminating film 11 with general structures by adhesives and the like. However, bonding the reinforcement sheet over the whole surface of the laminating film 11 is not applicable since it becomes difficult to vertically seal and horizontally seal the packaging sheet film 11. In other words, it is necessary that the sealant layer 12 is provided to the outermost surface of the inner side of the portions subject to the vertical seal and horizontal seal of the bag. Therefore, in the present invention, when the reinforcement sheet 14 is provided, lamination is performed within the range that includes the range where the three dimensional designs are formed and that excludes the sealed range. In other words, it is preferable that the three dimensional designs for the bag 10 of the present invention are performed at predetermined portions within the range where the reinforcement sheet 14 is laminated in the inner side surface corresponding to the outer side surface of the bag 10.

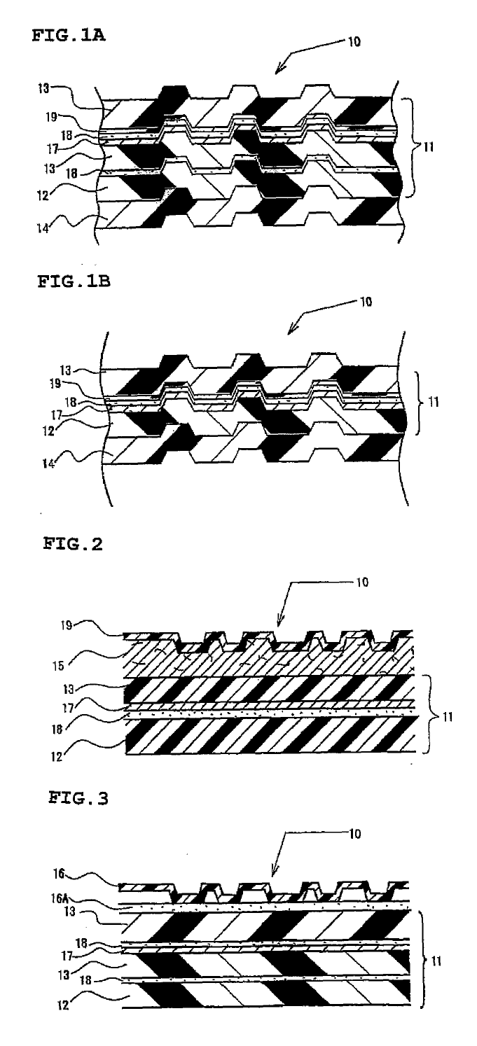

The schematic sectional view as one example of the structure of the bag when the reinforcement sheet 14 is provided on the laminating film 11 is shown in FIGS. 1A and 1B. The layer structure of the bag 10 shown in FIG. 1A is, starting from the inner side, the reinforcement sheet 14/the sealant layer 12/the adhesive or the polyethylene layer 18/the substrate layer 13/the barrier layer 17/the adhesive 18/the printing layer 19/the substrate layer 13. As another example of the structure, the example shown in FIG. 1B is constituted of, starting from the inner side, the reinforcement sheet 14/the sealant layer 12/the barrier layer 17/the adhesive or the polyethylene layer 18/the printing layer 19/the substrate layer 13. However, as mentioned above, in the both structures, the outermost layer in the inner side at positions where the vertical seal and horizontal seal are performed is a sealant layer 12 and the reinforcement sheet is not laminated on this portion.

### Sheet For Three Dimensional Designs

In the present invention, it is preferable that the three dimensional designing sheet 15 is laminated on the substrate layer side of the laminating film 11 and that the three dimensional design is formed by the mold to the laminating film 11 in which the three dimensional designing sheet 15 is laminated. In addition, when the three dimensional designing sheet 15 is used, the laminating film 11 with the three dimensional designing sheet 15 laminated may be prepared by preparing the laminate with the substrate layer 13 and the three dimensional designing sheet 15 laminated beforehand before forming the laminating film 11.

As a material for the three dimensional designing sheet 15, paper can be used. In particular, the paper with extendable property provided by fine unevenness is preferable. Such paper, by being used laminated on the laminating film 11, can provide mechanical properties such as strength, hardness, and the like and also, due to the excellent processing property of paper with extendable property, can easily form the three dimensional designs on the surface of the packaging bag for its uniquely shaped mold during the bag molding process. In addition, since the paper imparted with the extendable property by the fine unevenness has high shape retention property, the paper with once the three dimensional designs formed by the mold can keep retaining the three dimensional designs for a long term.

As the paper used in the present invention with the extendable property provided by fine unevenness, Clupak paper utilizing shrinkage of a rubber belt and produced by making the rubber belt shrink, crepe paper produced by wrinkling wetted paper on a press roll or a drier roll using a doctor blade, paper with lateral and longitudinal stretches imparted at once by making it condense between a pair of rollers, and the like can be exemplified. Further details of such paper are disclosed in Patent Documents 2 (Re-disclosure in Japanese text WO2004/028802) and 3 (Japanese Patent Publication H11-509276).

As specific measures for obtaining the paper with the above mentioned properties, it is easy to obtain the trade name “wavywavy” manufactured and sold by Nippon Paper Group, Inc. Since this paper has strength of 4 kN/m in 100 g/m² and has stretch of 15%, it can have usability alone as the three dimensional designing sheet 15 and the substrate layer 13, however, it is preferable to use polyethylene, polypropylene, polyester film as materials for the substrate layer 13 and laminate them with the substrate layer 13. Regarding the laminating methods of the three dimensional designing sheet 15 and the substrate layer 13 for the paper substrate used in the present invention to which the extensible property is imparted, it can be performed by publicly known methods and for example, it is stated in Patent Document 3. It is preferable that the weight of the paper used in the present invention is 50 to 300 g/m².

A schematic sectional view showing one example of the structure of the bag 10 when the sheet for the three dimensional designs is provided is shown in FIG. 2. The structure of the layer of the bag 10 shown in the FIG. 2 is, starting from the inner side, the sealant layer 12/the adhesive 18/the barrier layer 17/the substrate layer 13/the three dimensional designing sheet 15/the printing layer 19. In addition, the embodiment shown in FIG. 2 shows the embodiment in which the three dimensional designing sheet 15 and the printing layer 19 are different layers, however, when the paper printed with the ink jet is used as the three dimensional designing sheet 15, the illustrated printing layer 19 is integrated with the illustrated three dimensional designing sheet 15.

### Three Dimensional Sheet

A three dimensional sheet 16 is a sheet imparted with the three dimensional designs beforehand by such methods as embossing by the molds and the like. Since the three dimensional sheet 16 is required to retain the three dimensional designs even when some shocks are applied to the surface of the bag 10, it is preferable that the materials used for the three dimensional sheet 16 are materials with a certain degree of strength. To be specific, it is preferable that the three dimensional sheet 16 is constituted of the same materials as those used for the substrate layer 13 such as polypropylene, polyester, and the like. The three dimensional sheet 16 can be made into a bag 10 integrated with the laminating film 11, by being bonded with the laminating film 11 at the portion where no three dimensional designs is provided that is the surrounding portion of the three dimensional designs provided in the three dimensional sheet 16. In addition, the size of the three dimensional sheet 16 can appropriately be selected by the size of the bag and that of the three dimensional designs formed on the surface of the bag.

In the bag 10 of the present invention, the three dimensional sheet 16 provided with printing can also be used. In this case, instead of providing the printing layer on the laminating film 11, the three dimensional sheet provided with the printing can be used or, the printing can be provided to the three dimensional sheet 16 as well as to provide the printing layer 19 with the laminating film 11.

### Hot Melt Adhesive

As adhesives for bonding the three dimensional sheet 16 to the laminating film 11, hot melt adhesives 16A can preferably be used. Hot melt adhesives 16A are adhesives based on a thermoplastic polymer being solid at room temperature with a property of showing fluidity in a liquid state when heated and restoring the original solid state when cooled. To be specific, reactive type hot melt urethane series adhesives and copolymer polyester series hot melt adhesives can preferably be used.

A schematic sectional view as one example of the bag 10 produced by the apparatus of the present invention when the three dimensional sheet 16 is provided to the laminating film 11 using the hot melt adhesive 16A is shown in FIG. 3. The structure of the layer of the bag 10 shown in the FIG. 3 is, starting from the inner side, the sealant layer 12/the adhesive or a polyethylene layer 18/the substrate layer 13/the barrier layer 17/the adhesive 18/the substrate layer 13/the hot melt adhesive 16A/the three dimensional sheet 16. In addition, the schematic sectional view in FIG. 3 shows the embodiment of the three dimensional sheet 16 provided with printing without providing the printing layer to the laminating film 11.

### Printing Layer

The printing layer 19 is a layer for providing letters, patterns, and the like on the outer side surface of the packaging bag. The printing layer 19 can be formed by using the publicly known printing methods such as screening printing methods and the like. It is necessary that the printing layer 19 is in the outer side than the opaque barrier layer 17. In order to arrange the printing layer in the outer side than the barrier 17, for example, the substrate layer 13 is prepared as a double-layered film structure, one film of which is subject to the printing by a known printing method such as screen printing and the like, and the other film of which is subject to the formation of the barrier layer 17 by such methods as vapor deposition method and the like, thereby capable of laminating the both films to form the substrate layer 13 so that the printing layer is in the outer side.

In addition, in the present invention, when the three dimensional designing sheet 15 is laminated on the laminating film 11 and the material of the sheet for the three dimensional designs is paper, printing can easily be made on the paper that is the sheet for the three dimensional designs by such publicly known methods as ink jet methods and the like even without providing the printing layer separately.

### Bag Making-Packaging Machine

As one example of the bag making-packaging machine of the present invention used for forming the packaging bag from the laminating film 11, explanation is hereinafter made taking a vertical packaging machine as an example.

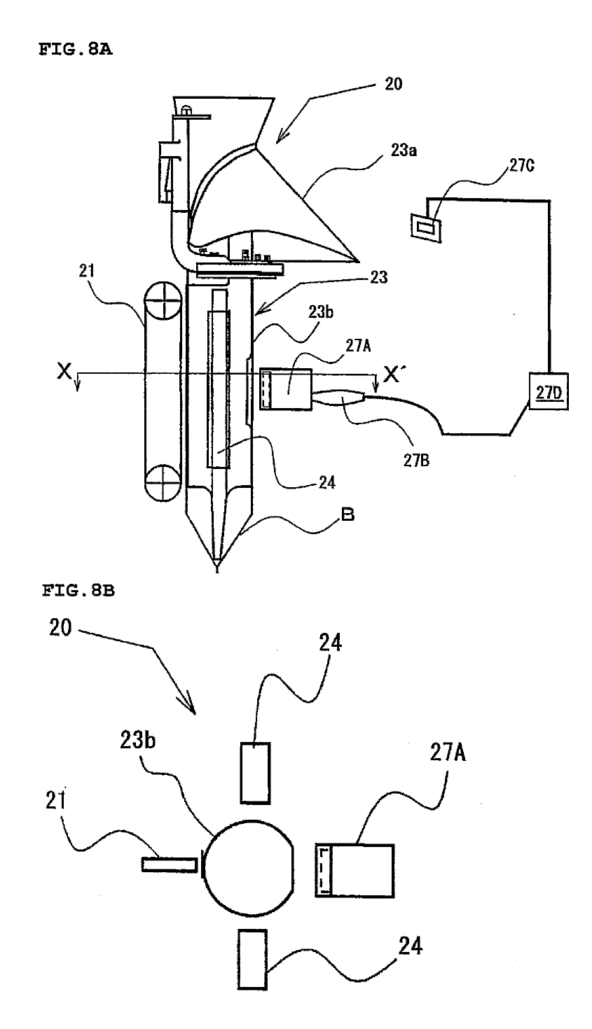

An example of the general vertical packaging machine is shown in FIG. 8. The vertical bag making-packaging machine for vertical packaging is generally constituted of a former 23 for molding the laminating film 11 supplied from a roll (not illustrated) into tubular, a pull-down mechanism 24 for forwarding the tubularly shaped laminating film 11 downward along the former 23, a vertical seal mechanism 21 for sealing the overlapped portions of the tubular laminating film 11 in the length direction on the former 23, and a pair of horizontal seal mechanisms 22 for horizontally sealing the vertically sealed tubular laminating film 11 at predetermined intervals.

### Former, Pull-Down Apparatus

The former 23 is a guide for placing the laminating film 11 along and is constituted of a shoulder portion 23a with a curved surface and a tubular portion 23b with a tubular shape. The pull-down apparatus 24 is an apparatus for forwarding the tubularly formed laminating film 11 downward along the former 23. The pull-down apparatus 24 is generally constituted of a belt 24c and a plurality of rollers 24a and 24b for driving the belt.

### Vertical Seal Mechanism, Horizontal Seal Mechanism

The vertical seal mechanism 21 is a mechanism for sealing by overlapping the end surfaces in the length direction of a tubularly formed laminating film 11. It is general that the vertical seal mechanism 21 is provided with a heating belt and a heating roller for sealing. On the other hand, the horizontal seal mechanism 22 is a mechanism for horizontally sealing the vertically sealed tubular laminating film at predetermined intervals. Since the molding of the three dimensional designs to the laminating film 11 is more easily conducted when performed intermittently by a mold 26 in the present invention, it is preferable to perform seal formation by the vertical seal mechanism 21 and the horizontal seal mechanism 22 as well in accordance with the timing. One of the horizontal seal mechanisms 22 has a knife for cutting the laminating film vertically and the other is provided with a groove to receive the knife and after sealing the laminating film 11, it is cut vertically and the bottom portion of the next bag is formed as well as letting the formed bag fall downward.

### Mold

In the bag-making and packaging machine 20 used for providing the bag of the present invention, in addition to the above mentioned structure, the mold 26 is provided so as to impart three dimensional designs to the laminating film 11. The mold 26 is used for forming the three dimensional design decorations on the predetermined surface of the laminating film 11. As molding methods by the mold 26, any of vacuum molding, air pressure molding, pressing molding, or emboss molding that are used in plastic molding are applicable. In particular, from the view point of good passability through the clearance between the shoulder portion 23a and the tubular portion 23b of the former 23, it is preferable that the three dimensional design formations to the laminating film are performed by forming the mold 26 to the tubular portion 23b.

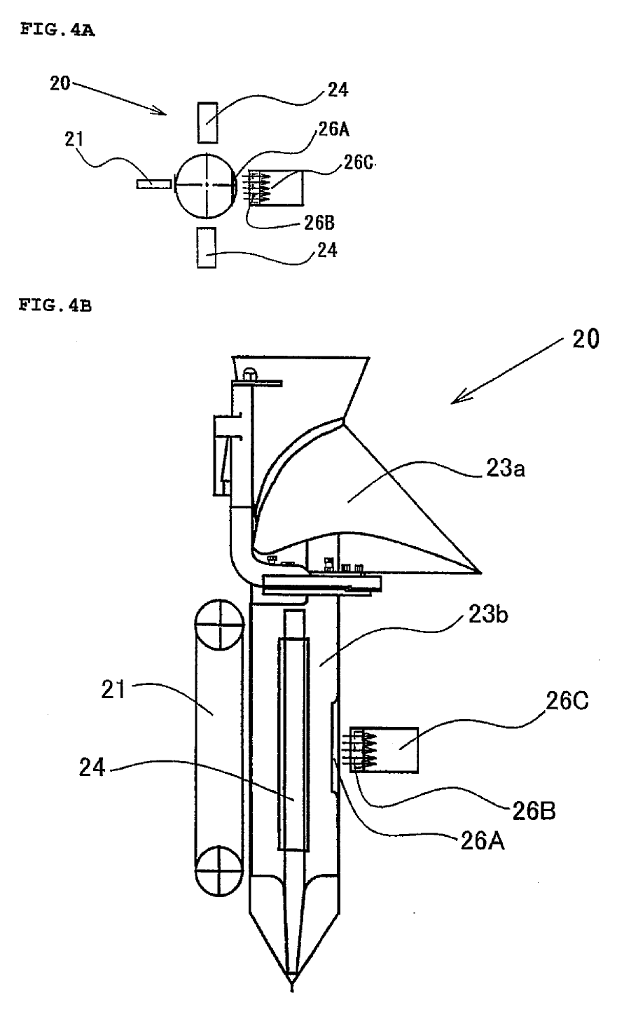

In FIGS. 4A and 4B, one example of the bag-making and packaging machine 20 used in the present invention is shown with the mold 26 built in. FIG. 4A is a schematic sectional view of the tubular portion 23b of the former provided with the mold for the three dimensional designs for producing the packaging bag of the present invention shown from the above direction and FIG. 4B is the schematic view seen from the lateral direction.

Since the general bag-making and packaging machine 20 has the vertical mechanism 21 at the front surface of the former 23 and has the pull-down mechanism 24 at both side surfaces of the former 23, it is preferable that the mold 26 is provided at the rear surface of the former 23 as shown in FIG. 4 (A). When such an alignment is employed, the three dimensional designs can be formed at a predetermined portion avoiding the position where the laminating film 11 is vertically sealed.

As shown in FIGS. 4A and 4B, as the mold 26, the male 26A is provided the tubular portion 23b of the former and the female 26B is provided to the position that is opposed to the male 26A. It is preferable that the female 26B is imparted with a heater function. The female 26B is provided with a mechanism for moving toward and away from the male 26A. The mold 26 controls the movement of the female 26B while detecting the register mark of the laminating film 11 thereby forming the three dimensional designs at a predetermined portion of the laminating film 11. A blower 26C is provided so as to apply the vacuum pressure between the male 26A and the female 26B when molding. In addition, since molding is preferably conducted under heating, it is preferable that the heater is built in the female 26B.

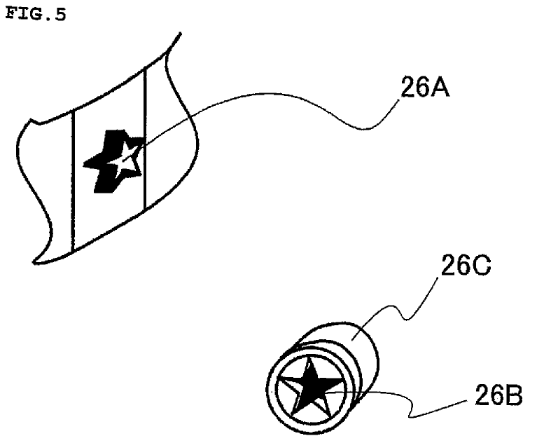

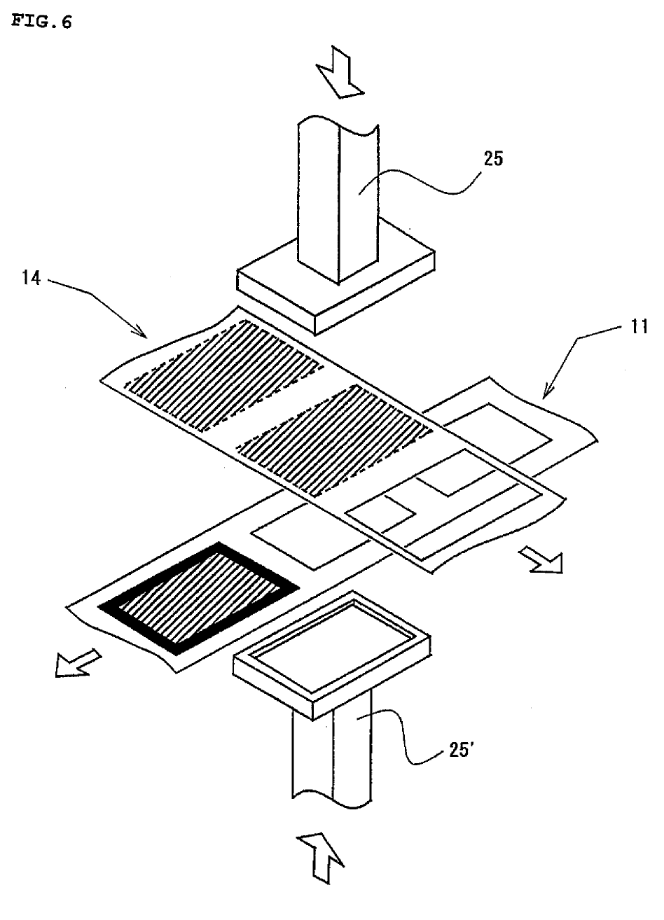

One example of the mold 26 used in the present invention is shown in FIG. 5. As shown in FIG. 4A, the male 26A is formed as shown in FIG. 5 on the flat surface when the tubular portion 23b of the former to which the mold is attached is defined to be the flat surface as shown in FIG. 4A, and in this case, it is also easy that the female 26B is provided with the mold on the flat surface. However, the mold 26 can also be formed along with the curved surface of the former.

### Bonding Mechanism of the Reinforcement Sheet

In the present invention, when the bags with the embodiment of providing the reinforcement sheet 14 are produced, in the bag-making packaging machine 20, it is preferable to provide the bonding mechanism for bonding the reinforcement sheet 14 in the substrate layer side of the laminating film 11 in the process before imparting the three dimensional designs to the laminating film 11 by the mold 26.

In FIG. 6, an outline is shown on one example of the bonding mechanism for the reinforcement sheet 14. The bonding mechanism of the reinforcement sheet is the mechanism for bonding the reinforcement sheet intermittently to the laminating film 11. Before the laminating film 11 is supplied to the vertical bag-making and packaging machine 20, the reinforcement sheet 14 is laminated at predetermined portions that are the surfaces of the sealant layer of the laminating film 11 and that exclude the portions where the vertical seal and the horizontal seal are formed, and the example in the FIG. 6 shows that the surfaces laminated on the laminating film of the reinforcement sheet 14 have a heat-sealable property. As shown in the FIG. 6, the reinforcement sheet 14 is supplied on the laminating film 11 as a continuous film, and the region laminated on the laminating film 11 is divided by the perforation, and the divided portions are laminated to the laminating film 11 by the hot press machine provided with heater plates 25 and 25′ as shown in the FIG. 6. The heater plates 25 and 25′ of the hot press machine may be the one that fixes the peripheral portions of the reinforcement sheet to the laminating film 11 as shown in the FIG. 6, or may be the one that fixes the whole surface.

In addition, as other embodiments, the reinforcement sheet with an adhesive layer or a sticky layer is laminated on release paper, with slits in the predetermined portions, dividing the predetermined regions, thereby laminating on the laminating film interposing the adhesive layer or the sticky layer while removing the release paper.

The size of the reinforcement sheet 14 is selected depending appropriately on the size of the bag and on the size of the three dimensional designs formed by the bag surface. Further, the positioning of the bonding the reinforcement sheet 14 can be conducted by controlling the bonding mechanism for the reinforcement sheet while detecting the register marks that are printed on the laminating film 11.

### Bonding Apparatus

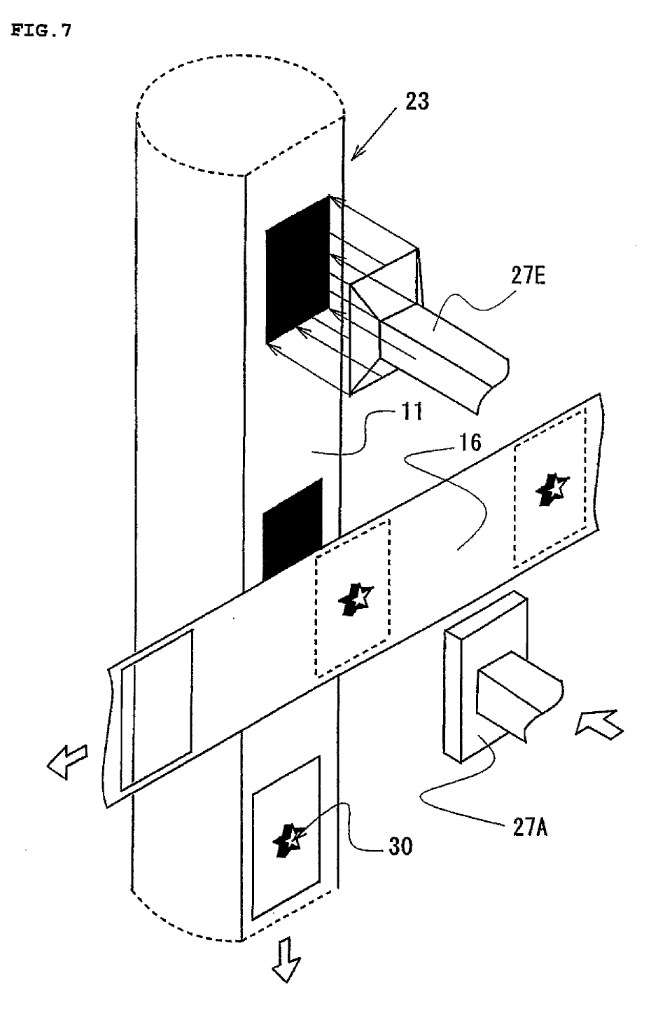

Or instead of building the mold 26 in the bag-making packaging machine 20 as mentioned above, a mechanism for bonding the three dimensional sheet 16 with the three dimensional shape imparted using the mold 26 beforehand may be built in the bag-making packaging machine 20. In FIG. 7, the outline is shown on the pivotal portion of this bonding mechanism. In order to show the positioning relationship of the bonding mechanism in the bag-making packaging machine 20, FIGS. 8A and 8B show the schematic lateral view (FIG. 8A) and the schematic sectional view taken along the line X-X′ (FIG. 8B). It is preferable that the bonding mechanism is provided with a bonding apparatus 27A, a moving mechanism 27B, a sensor 27C, a controlling mechanism 27D, and a spraying apparatus 27E.

It is preferable that the bonding apparatus 27A is provided at a position opposite to the former 23 of the bag making-packaging machine 20. When the three dimensional sheet 16 is bonded to the plane laminating film 11 before introduced to the former 23, defects such as crushes of the three dimensional designs and the like are likely to occur when the laminating film 11 is deformed into tubular along the former 23.

Since the bonding of the three dimensional sheet 16 is conducted intermittently, it is preferable that the bonding mechanism is provided with the moving mechanism 27B capable of moving the bonding apparatus 27A toward the former surface when bonded and moving the bonding apparatus 27A away from the former surface except for bonding.

In the producing method in which the sealant layer 12 or the hot melt adhesive 16A are formed beforehand at the rear surface of the three dimensional sheet 16 and the three dimensional sheet 16 is heated thereby bonding is made, it is preferable that the bonding apparatus 27A is provided with a heating plate (not illustrated) capable of pressing down the three dimensional sheet 16 at predetermined portions and heating the three dimensional sheet 16 as well. In the heating plate, a heating mechanism is built in. The heating plate is capable of heating the three dimensional sheet 16 by the contact of the three dimensional sheet 16 and the laminating film 11 even before the three dimensional sheet 16 and the laminating film 11 contact with each other. In the step where the three dimensional sheet 16 contacts with the laminating film 11 thereafter, since the sealant layer or the hot melt adhesive at the rear surface of the three dimensional sheet 16 has strong bonding force, both can be integrated to a full extent even if the contact time period of the three dimensional sheet 16 and the laminating film 11 is short. In addition, in FIG. 7, black surfaces on the laminating film 11 show the predetermined portions to which the three dimensional sheet is bonded.

### Spraying Apparatus

In the producing method in which a melted hot melt adhesive is sprayed to the surface of the laminating film 11 thereby integrating both by bonding the three dimensional sheet 16 while the hot melt adhesive is melted during the process right before bonding the three dimensional sheet 16, the bag-making packaging machine 20 of the present invention can further be provided with the spraying mechanism 27E for spraying the melted hot melt adhesive. FIG. 7 shows the outline of the spraying mechanism 27E. In addition, in FIG. 7, black surfaces on the laminating film 11 show the predetermined portions to which the hot melt adhesive 16A is sprayed by the spraying mechanism 16A.

It is preferable that the spraying mechanism 27E is provided with a storage portion (not illustrated) for storing the hot melt adhesive, a heating mechanism (not illustrated) for melting the hot melt adhesive, and a nozzle (not illustrated) for spraying the melted hot melt adhesive. Also, in addition, the moving mechanism (not illustrated) can be provided as in the bonding apparatus 27A so that it approaches to the laminating film 11 on the surface of the former 23 only at the time of spraying. When the moving mechanism is provided, in order to determine the accurate spraying position, the spraying apparatus 27E can be controlled by the positioning mechanism as in the bonding mechanism. In the producing method by this embodiment, both the laminating film 11 and the three dimensional sheet 16 can be integrated to a full extent even if the contact time period for the two is short since the hot melt adhesive is subject to heating in the storage portion beforehand.

### Positioning Mechanism

Basically, the positioning mechanism is constituted of the sensor 27C for detecting the register marks of the laminating film 11, the moving mechanism 27B for moving the bonding apparatus 27A by the signal from the sensor 27C, and the controlling mechanism 27D for controlling the movement. By providing such a positioning mechanism, the movement of the bonding apparatus can be controlled. The three dimensional design sheet 16 can be bonded to the predetermined position of the laminating film 11 accurately. The register marks need not be detected for the tubular laminating film 11 placed along the former 23 but can be detected for the plane laminating film 11 before the introduction of the former 23 as shown in FIG. 8A.

### Production 1 of Bags With Three Dimensional Designs

A producing method of bags provided with the three dimensional designs to the laminating film 11 using the bag making-packaging machine by the mold is as follows. First of all, the laminating film 11 is provided to the bag making-packaging machine 20 taking out the laminating film 11 from the feed roll with the laminating film 11 rolled. The laminating film 11 moves toward the shoulder portion 23a of the former 23, conveyed by the pull-down belt 24c of the bag making-packaging machine 20. When the embodiment of bonding the reinforcement sheet 14 is employed, in the process so far, the reinforcement sheet 14 is bonded to the predetermined positions with constant intervals by the bonding mechanism of the reinforcement sheet on the inner side surface of the laminating film 11. However, this time, the reinforcement sheet 14 is not bonded to the position for vertical seal and horizontal seal in the process afterwards. The laminating film 11 is formed in tubular in the process of conveying the laminating film 11 from the shoulder portion 23a of the former 23 of the bag making-packaging machine 20 to the tubular portion 23b, and then both film ends are overlapped in the film running direction while moving downward along the former surface, thereby performing vertical seal by the vertical seal mechanisms 21. As types of vertical seal, either an envelope seam sealing or a butt seam sealing is applicable.

On the rear surface of the former, the three dimensional designs are formed to the laminating film 11 by the mold 26, while on the front surface of the former, the vertical seal is performed to the laminating film. A flow chart is shown in Table 1 in which the molds 26 (26A, 26B, and 26C) shown in FIG. 5 are used for the apparatus shown in FIGS. 4A and 4B.

TABLE 1

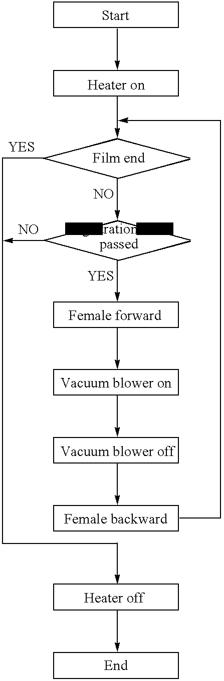

As above mentioned, the preferable embodiment of the present invention is that the mold 26 provided to the former 23 is the male 26A and the opposing mold is the female 26B. In the female 26B, the heater (not illustrated) for heating the laminating film 11 is built in, and the blower 26C for depressurizing inside of the mold when molding, and the moving mechanism (not illustrated) for forwarding and reversing the female toward the male 26A are provided. The register mark is detected by the sensor (not illustrated) in the process where the laminating film 11 is supplied to the former 23, and based on the information from the sensor, the position of the laminating film 11 at which the three dimensional designs are to be formed is specified. In order that the three dimensional designs are formed at specified positions, the female 26B moves forward and at the same time, the vacuum blower 26C starts operation, thereby inside of the mold 26 is made vacuum and the molding is conducted. After the three dimensional designs are formed, the operation of the blower 26C stops and the female 26B moves backward.

Next, the laminating film 11, with its lower end sealed by the horizontal seal mechanism 22 at appropriate intervals, is processed to be formed as an uncompleted bag with its upper end opened and at the same time, the product C is supplied to the uncompleted bag passing through the inner side cavity of the tubular portion 23b. Lastly, when the upper end of the uncompleted bag is sealed by the horizontal seal mechanism 22 and is cut out into separate bags by the knife of the horizontal mechanism 22, the three dimensional designs are provided on the surface and the bag 10 tightly packed and filled with the product C is completed.

In addition, although the process of forming the three dimensional designs at the time of the vertical seal of the laminating film 11 was shown in the producing method, such a process can also be employed in which the vertical seal is conducted before and after the molding of the three dimensional designs are performed.

### Production 2 of Bags With Three Dimensional Designs

The method for producing the bag 10 with the three dimensional designs using the three dimensional sheet 16 is more or less different from the above mentioned method. It is common with the above mentioned producing method in that the laminating film 11 moves downward along the former surface.

Along with the laminating film 11 vertically sealed, on the rear surface of the former 23, the three dimensional sheet 16 is bonded to the predetermined position with constant intervals by the bonding mechanism of the three dimensional sheet 16. At this stage, by making the bonding position of the rear surface of the former 23 flat, the three dimensional sheet 16 can be bonded without failure. However, at this time, the three dimensional sheet 16 is not bonded to the position to be horizontally sealed in the process afterwards.

Methods for bonding the three dimensional sheet 16 to the laminating film 11 include the one which uses the three dimensional sheet 16 provided with the sealant layer or the hot melt adhesive 16A beforehand on the rear surface of the three dimensional sheet 16, that is the surface bonded to the laminating film 11, followed by heating this three dimensional sheet 16 to bond it or the one in which the melted hot melt adhesive is sprayed to form the hot melt adhesive 16A at predetermined portions on the surface bonded to the surface of the laminating film, that is, the surface bonded to the three dimensional sheet 16 in the process right before bonding the three dimensional sheet 16 as shown in FIG. 7, thereby bonding the three dimensional sheet 16 while the hot melt adhesive 16A is being melt.

The three dimensional sheet 16 before bonded to the laminating film 11 can be prepared as, as shown in FIG. 7, a continuous sheet in which the sheet portion to be bonded to the bag is divided by the perforation. The portions divided by the perforation break by applying force by the bonding apparatus 27A thereby bonded to the surface of the laminating film 11.

In the methods in which the sealant layer or hot melt adhesive is provided at the rear surface of the three dimensional sheet 16, while the bonding apparatus 27A pressurizes the positions divided by the perforations of the three dimensional sheet 16 and imparts heat, and while the three dimensional sheet 16 moves to the predetermined positions of the laminating film 11, the three dimensional sheet 16 is bonded by the adhesive force of the sealant layer or the hot melt adhesive at the rear surface of the three dimensional sheet 16.

On the other hand, in the methods in which the hot melt adhesive is formed by such methods as spraying, a hot melt adhesive is sprayed by the adhesive spraying apparatus 27E with the heating mechanism built in as shown in FIG. 7, on the predetermined portions on the front surface side of the laminating film 11 made into tubular by the former 23. Next, while the hot melt adhesive 16A retains the melted state, the three dimensional sheet 16 is bonded by the bonding apparatus 27A.

After the completion of the bonding process, the bonding apparatus 27A retires. Such operation of the bonding apparatus 27A or that of the spraying apparatus 27E is controlled by cooperation of the moving mechanism 27B, the sensor 27C and the controlling mechanism 27D.

It is common with the above mentioned producing method in that the bag is tightly sealed by the vertical seal after the product C is filled in the uncompleted bag at the last stage.

### Bags To Be Produced

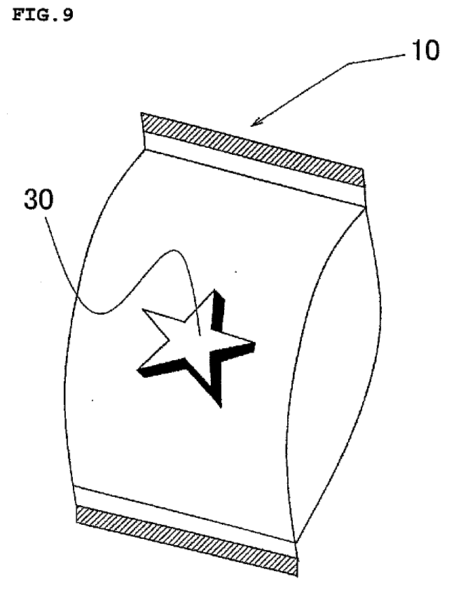

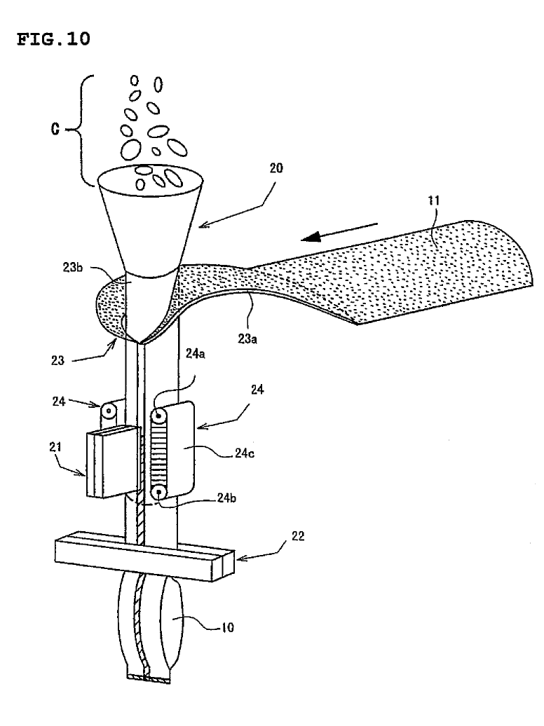

FIG. 9 shows one example of the appearance of the bags produced by the above mentioned producing method with the three dimensional designs 30 formed. Contents of the three dimensional designs 30 include product images, designs forming the corporate images that provide the products, catchphrases as promotions for the products, and the like, and it is effective for the three dimensional designs 30 to form a depth of 1 to 20 mm, and in particular, not less than 10 mm.

### Shapes of the Bags

Since the producing methods by the vertical packaging machines have been exemplified, the vertical bags with the three dimensional designs are produced, however, the packaging bags in the present invention are not limited to these vertical bags, and square bags with gussets or rectangular sealed bags can also be produced.

### INDUSTRIAL APPLICABILITY

Since the packaging bags with the three dimensional designs formed on the packaging bag surfaces by the bag making-packaging apparatus of the present invention, the consumer appetite is stimulated and the sales of the merchandizes are improved by employing these packaging bags.

Also, since the present invention has a merit in that the consumers come to see the indication of the bags more attentively, messages from the manufacturers are better known to the consumers. Therefore, the present invention can be used extensively for the bags for packaging foods and the like and the producing methods therefor.

What is claimed:

1. A bag with three dimensional designs provided with a front surface and a rear surface that are formed by sealing a laminating film with a substrate layer and a sealant layer vertically and horizontally, wherein the three dimensional designs molded by a mold are formed on at least either of the front surface or the rear surface.

2. The bag as set forth in claim 1, wherein the three dimensional designs are formed by laminating the three dimensional sheet with the three dimensional designs molded by the mold formed on the substrate layer side.

3. The bag as set forth in claim 1, wherein a reinforcement sheet is laminated on the inner side surface of the laminating film in the range that includes the range on which the three dimensional designs are formed and that exclude the range to be sealed.

4. The bag as set forth in claim 1, wherein the three dimensional designs are formed by laminating the sheet for the three dimensional designs that include paper imparted with an extending property by the fine unevenness on the substrate layer side of the laminating film and by forming the three dimensional designs by the mold to the laminating film with the sheet for three dimensional designs laminated.
